(19) United States
(12) Patent Application Publication
(10) Pub. No.: US 2001/0042705 A1
(43) Pub. Date: Nov. 22, 2001

(54) Method for classifying defects and device for the same

(76) Inventors: Ryou Nakagaki, Kawasaki (JP); Yuji Takagi, Kamakura (JP); Kenji Obara, Ebina (JP); Yasuhiko Ozawa, Abikoi (JP); Toshiei Kurosaki, Hitachinaka (JP); Takehiro Hirai, Hitachinaka (JP)

Correspondence Address: TOWNSEND AND TOWNSEND AND CREW, TWO EMBARCADERO CENTER, EIGHTH FLOOR, SAN FRANCISCO, CA, 94111-3834, US

(21) Appl. No.: 09/823,638

(22) Filed: Mar. 30, 2001

(30) Foreign Application Priority Data
May 18, 2000 (JP) 00-152663

(51) Int. Cl. B07C 5/34

(52) U.S. Cl. 209/44.4; 209/571; 209/573

(57) ABSTRACT

A method for classifying defects includes imaging an inspected object. An image of a defect candidate is extracted from an image obtained by said imaging step. Said extracted defect candidate image is classified into a first category. Said extracted defect candidate image is classified into a second category. Said extracted defect candidate image and information relating to said classification into said first category and information relating to said classification into said second category are displayed on a screen.

### CROSS-REFERENCES TO RELATED APPLICATIONS

This application claims priority from Japanese Patent Application No. 00152663, filed May 18, 2000, which is incorporated by reference for all purposes.

### BACKGROUND OF THE INVENTION

The present invention relates to a method for detecting defects in a semiconductor wafer in a semiconductor product production process and classifying the defected defects, and a device for the same.

In semiconductor product production processes, various types of defects generated in the production process must be discovered and dealt with early in order to maintain high product yields. This is generally achieved through the following steps. First, a semiconductor wafer to be inspected is inspected using a wafer visual inspection device, a wafer particle inspection device or the like to detect locations of generated defects and particles. Second, the detected defects are observed (this is known as reviewing), and these defects are classified according to the causes generating the defects. This reviewing operation generally involves a dedicated reviewing device with a microscope or the like to observe the defect positions at a high magnification. However, it would also be possible to use a different device, e.g., a visual inspection device, equipped with a reviewing feature. Third, response measures are taken based on these causes.

If a large number of defects is detected by the inspection device, the reviewing operation requires a large amount of work. Thus, recent years have seen significant development taking place around reviewing devices having automatic defect review features, in which images of defect positions are automatically captured and collected, and automatic defect classification features, in which collected images are automatically classified. Japanese laid-open patent publication number Hei 10-135288 discloses a reviewing device and production system having these types of automatic review and automatic defect classification features. In this conventional technology, classification categories, information relating to defects belonging to these categories, and the like are registered beforehand as training data. Then, when automatic classification is performed, the categories for defects are determined by referring to the training data.

However, this conventional technology is based on storing classification categories as training data. In creating the training data, defect images for defects belonging to each category must be collected and features of these images must be calculated and registered. Thus, a large amount of time and labor is required to create the training data.

Not all generated defects influence the good/faulty evaluation of the final product. For example, even if a particle is present on the surface of a pattern, this particle cannot be assumed to be the cause of a faulty product if it does not affect the electronic characteristics of the circuit. In the conventional technology described above, defects are classified into categories based on visual attributes of defects such as adhesed particles and pattern breaks. This provides information that is useful in setting up measures against the causes of defects, but it is not possible to evaluate whether the defects are critical to the product. The conditions in which defects critical to the product are generated cannot be studied, and predictions of the number of good products to be obtained from the wafer (predicted yield) cannot be made.

### BRIEF SUMMARY OF THE INVENTION

The object of an embodiment of the present invention is to overcome the problems of the conventional technology described above and to provide an automatic classification method and device for classifying defects to provide information relating to defect criticality separately from defect classification that provides information useful to determining causes generating the defects, and outputting this information.

An embodiment of the present invention provides a method for classifying defects in which an inspected object is imaged and the resulting images are used to classify defects on the inspect object. The inspected object is imaged, and images of defect candidates are extracted from the images obtained from this. The images of extracted defect candidates are classified by defect type, and the criticality of these defect candidates classified by type is evaluated. The defect candidate images and information relating to defect types and criticality are displayed on a screen.

Another embodiment of the invention provides a method for classifying defects includes imaging an inspected object. An image of a defect candidate is extracted from an image obtained by said imaging step. Said extracted defect candidate image is classified into a first category. Said extracted defect candidate image is classified into a second category. Said extracted defect candidate image and information relating to said classification into said first category and information relating to said classification into said second category are displayed on a screen.

An embodiment of the present invention also provides a defect classification device. Means for imaging captures an image of an inspected object. Means for extracting defect candidates extracts images of defect candidate from the images obtained from the imaging means. Means for classifying a first category classifies images of defect candidates extracted with the defect-candidate-extracting means into a first category. Means for classifying a second category classifies images of defect candidates extracted with the defect candidate-extracting means into a second category. Means for outputting outputs defect candidate images and first category information of defect candidates classified by the first category-classifying means and second category information of defect candidates classified by the second-category-classifying means.

These and other objects, features and advantages of the invention will be apparent from the following more detailed description of embodiments of the invention, as illustrated in the accompanying drawings.

### BRIEF DESCRIPTION OF THE DRAWINGS

FIG. 1 is a block diagram showing an architecture of a semiconductor defect inspection system.

FIG. 2 is a drawing showing the flow of operations performed in ADR processing in a conventional technology.

FIG. 3 is a drawing showing the flow of operations performed in ADC processing in a conventional technology.

FIG. 4 is a drawing showing a sequence of operations performed in ADR processing in an automatic image classification device according to the present invention.

FIG. 5(a) is a block diagram showing an architecture of an automatic image classification device according to one embodiment of the present invention.

FIG. 5(b) is a front-view schematic drawing of an imaging module.

FIG. 6 is a drawing showing a sequence of operations performed in ADC processing in an automatic image classification device according to one embodiment of the present invention.

FIG. 7 is a cross-section drawing of a wafer for the purpose of illustrating voltage contrast defect imaging principles.

FIG. 8 is a drawing showing examples of categories according to one embodiment of the present invention.

FIG. 9 shows plan drawings and cross-section drawings schematically showing differences in surface shape in different types of defects.

FIG. 10 shows images corresponding to plan and cross-section views of a wafer, in which defect types and left and right images are schematically indicated.

FIG. 11 shows plan drawings of a wafer in which circuit pattern defects are indicated schematically.

FIG. 12(a), FIG. 12(c), and FIG. 12(d) show plan drawings of a wafer.

FIG. 12(b) illustrates image signal intensities associated with FIG. 12(a).

FIG. 13 is a voltage contrast image associated with plan drawings of a wafer.

FIG. 14 is an example of a table used to perform categorizing.

FIG. 15 is a plan drawing of a wafer in which killer and non-killer defects are indicated schematically.

FIG. 16 shows a sequence of operations performed in a criticality evaluation procedure for particle defects.

FIG. 17 is a defect image showing a sequence of operations for evaluating criticality.

FIG. 18 is a front-view drawing of a display screen showing a sample classification results display.

FIG. 19 is a front-view drawing of a display screen showing a sample classification results display.

FIG. 20 is an example of a categorization structure in an automatic classification device according to the present invention.

FIG. 21 is a plan drawing of a wafer in which sample defects are indicated schematically.

FIG. 22 shows a sequence of operations performed in a classification operation in an automatic image classification device according to the present invention.

FIG. 23 is a front-view drawing of a display screen showing a sample display of classification results.

### DESCRIPTION OF THE SPECIFIC EMBODIMENTS

The following is a detailed description of the embodiments of the present invention.

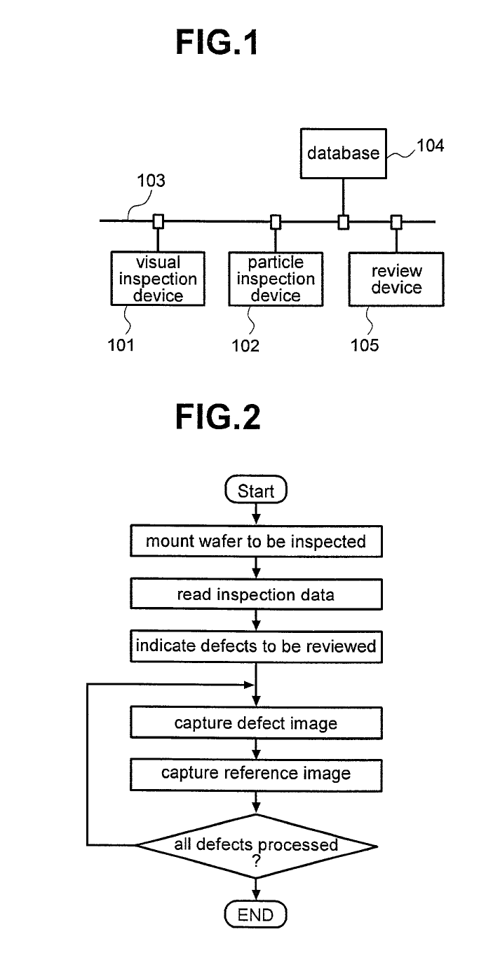

FIG. 1 shows an architecture of a system for inspecting defects in semiconductor materials. A semiconductor wafer is inspected using a visual inspection device 101 and a particle inspection device 102 to detect adhesed particles and defects generated in the production process. In the following description, these defect inspection devices are taken together and referred to as the “inspection device.”

The inspection device detects problems in the patterns formed on the wafer surface, e.g., pattern breaks (open patterns), short-circuits with adjacent patterns (shorts), and particles adhesed to the surface. The inspection result output from the inspection device is stored in a database 104 by way of a recording medium such as a floppy disk or by way of a network 103. The database 104 stores the various product types and the inspection data for the production processes thereof. Inspection result data can be accessed by product, by process, by production lot, or the like.

Next, a defect observation operation (review operation) is performed to study the details of the detected defects.

In order to study fine defects, a reviewing device 105 is generally equipped with an optical microscope or an electron microscope of the electron beam type. The reviewing device also includes a stage on which the wafer is mounted. When the operator selects a defect from the inspection results to be observed, the stage automatically moves so that the defect is placed in the field of view of the microscope. The review operation can also be performed using a visual inspection device having reviewing features rather than using this type of dedicated reviewing device.

A semiconductor wafer that has been inspected by the visual inspection device is set up in the reviewing device 105, and the inspection results are read from the database 104 by way of the network 103. If reviewing is to be performed manually, the operator generally uses inputting means such as a keyboard and mouse to specify defects, which are then observed under the microscope. The operator visually evaluates attributes (categories) of the defects and enters corresponding codes or the like.

The category codes set up for defects by the reviewing device 105 are stored in the database 104 by way of the network 103. These category codes can be used as data needed to determine defect generation conditions and defect prevention measures, e.g., defect counts for each category by product, by process, by time period, or the like. Performing the reviewing operation described above manually requires much time and work, so generally the defects to be observed are narrowed down to a subset of all the defects using some method rather than observing all the detected defects.

Recently, reviewing devices equipped with automatic reviewing features, i.e., Automatic Defect Review (“ADR”) have been developed. In these reviewing devices, defects to be observed are selected, the stage is moved, and images of defect positions are captured continuously and automatically. Also, reviewing devices equipped with automatic defect classification features, i.e., Automatic Defect Classification, (“ADC”) have been developed. In these reviewing devices, the image data for defect positions resulting from automatic reviewing operations is used to automatically evaluate and output defect categories. In the description below, an example is presented using a reviewing device equipped with an SEM (Scanning Electron Microscopy) imaging device, which can image defects at high resolutions of a few nm (nanometers). However, it would also be possible to use a reviewing device using an optical microscope.

FIG. 2 shows an example of the flow of operations involved in ADR. First, the inspected wafer is mounted on the stage of the reviewing device and inspection results are read. Next, the operator selects defects to be processed by ADR out of the inspection results obtained from the inspection device. If the ADR throughput is fast and the amount of detected defect data is small, all defects can be processed by ADR.

The reviewing device selects a defect out of the specified defects and moves the stage so that the defect position is roughly within the field of view of the observation system. Then, focus is set up to be optimal for capturing an image and an image is captured. This image will be referred to as the defect image The captured defect image is stored in a recording medium (e.g., a magnetic disk) in the reviewing device.

Next, the stage is moved and the corresponding defect position on a semiconductor chip adjacent on the wafer to the semiconductor chip containing the defect position is imaged This image will be referred to as a reference image. The reference image is also stored in the recording medium in the reviewing device. When the capturing of the reference image is completed, the defect image and the reference image for the next defect are captured in the manner described above.

The procedure is finished after these operations have been repeated for all the defects to be processed by ADR.

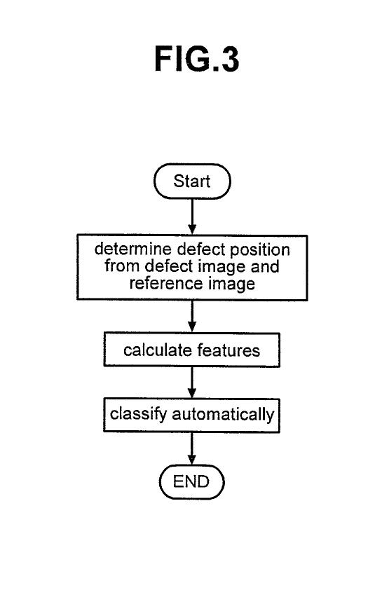

FIG. 3 shows an example of a flow of operations used in ADC processing. In ADC processing, the defect images and reference images from ADR processing are used to automatically determine categories for defects. First, a defect position is determined from the defect image and the reference image. More specifically, a differential image is generated by taking the difference between the defect image and the reference image. As a result, only the position where the defect image and the reference image are different appears in the differential image, and this position represents the defect position. Next, the features of the defect are calculated using this differential image, the defect image, and the reference image. Features are quantitative representations of characteristics such as defect size, defect shape, and image contrast. Next, the features data is used to perform automatic classification to determine a defect category.

Automatic classification generally requires training data, which is data created by training the reviewing device regarding categories used for classification. To create this training data, multiple sample defects for classification categories are collected beforehand. Next, the same feature values used in the automatic classification operation are calculated for these training samples. Feature values are stored for each classification category. These classification categories are categories defined by visual differences in defects, e.g., particle defects, flaw defects, pattern shorts, and open patterns.

During automatic classification processing, the similarity of the features of the defect being classified to the features of the classification categories stored in the training data are calculated. The defect category determined to be most similar is output as the category for the defect being classified.

One method for calculating similarity is described in the conventional technology presented in Japanese laid-open patent publication number 10-135288.

The ADR and ADC operations based on the conventional technology shown in FIGS. 1-3 have the following problems. First, the categories used for classification are defined based on visual observation of defects. This is because visually different defects can be considered to be caused by different factors. Thus, categorization based on visual observation of defects can aid in setting up measures to deal with defect causes.

However, with this method, ADR and ADC processing does not provide yield predictions, for which there has been an increasing demand. Yield predictions are predictions of the number of good products that can be obtained from a wafer being inspected. Semiconductor production involves a large number of processes, and if an inspection indicates that there a large number of killer defects on a wafer, it may be more cost effective to discard the wafer.

As used herein, the term “killer defects” refer to defects that ultimately result in faulty products in chips containing the defect. By considering the yield prediction results, the number of products to be produced, and the shipping date, the number of products to start production on next can be determined. To achieve this, ADR and ADC processing must be performed to automatically determine the criticality of each defect and predict the product yield for the wafer. The categorization based on criticality is performed based on different standards from the categorization performed through the visual observation of defects described above.

Also, in ADC processing according to the conventional technology, training data must be created. To have a high rate of accuracy in classification, a large number of sample defects with various variations must be collected and registered. However, semiconductor production cycles have been getting shorter and shorter in recent years, making the allocation of time to collect an adequate volume of sample defects difficult. Based on these considerations, there is a need for ADR and ADC features that perform automated classification based on defect criticality rather than visual features of defects and that also does not require the work involved in creating training data. Embodiments of the present invention, which overcomes these problems, will be described below.

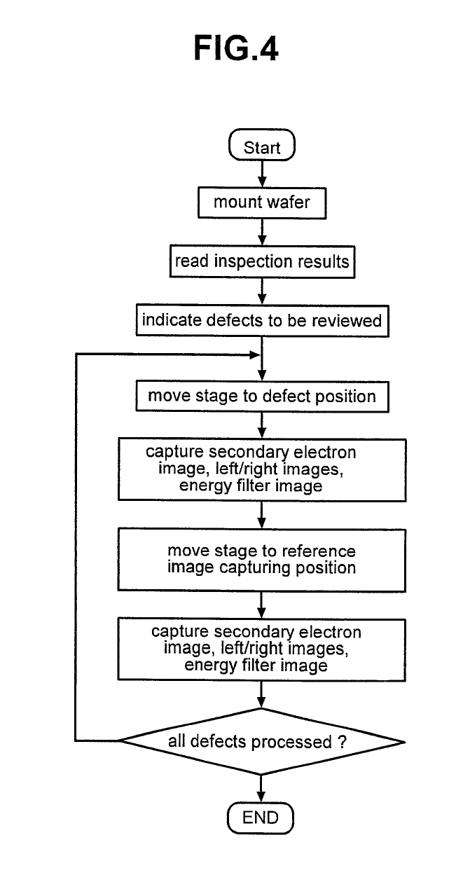

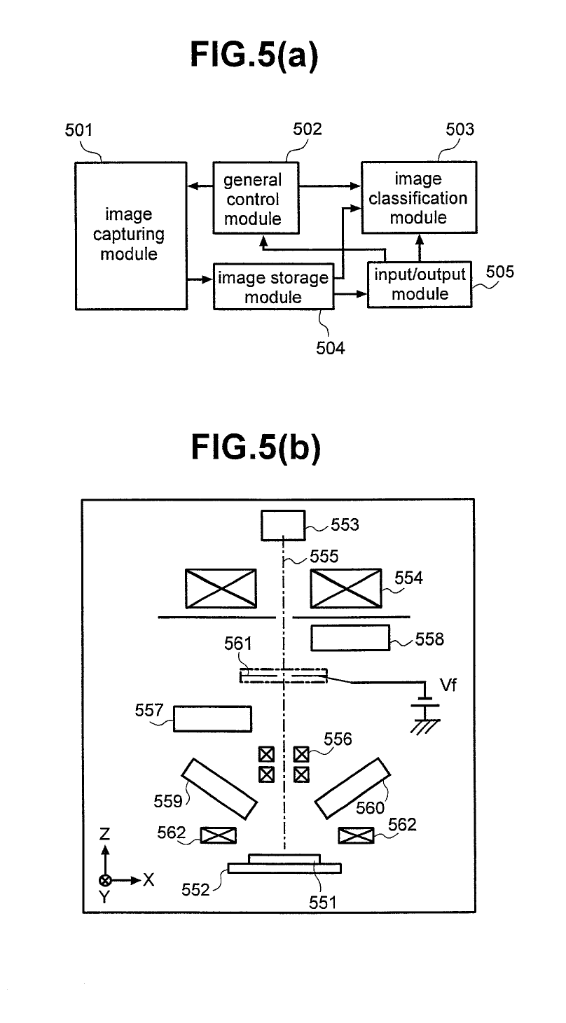

FIG. 4 shows the sequence of operations involved in the classification performed by an automated image classification device according to an embodiment of the present invention. FIG. 5(a) shows the overall architecture of the automated image classification device according to one embodiment of the present invention. FIG. 5(b) shows the architecture of an image capturing module.

The present device according to one embodiment includes an image capturing module 501, a general control module 502, an image classification module 503, an image storage module 504, and an input/output module 505. First, a wafer 551 is mounted on a stage 552. The inspection results for this wafer are read by the general control module 502. Next, using the input/output module 505, the operator specifies any number of defects to be processed by APR out of the defects from the inspection results. The selections are stored in the general control module 502.

When ADR processing is started, the stage is moved to align each defect to be processed by ADR into the field of view of the device and an image of the defect position is captured.

FIG. 5(b) shows an electron beam image capturing system. An electron gun 553 projects an electron beam 555, which is focused by a condenser lens 554. A deflector 556 deflects the path so that the beam is scanned in the X and Y directions in the figure. The beam is focused by an objective lens 562 and reaches the wafer 551.

Secondary electrons and reflected electrons (hereinafter referred to collectively as secondary electrons) are generated at the surface of the wafer illuminated by the electron beam. These secondary electrons are detected by detectors A, B, C, D (557-560). The intensities of the detected secondary electrons are converted into electronic signals, which are then amplified and converted into an image signal in which intensity is represented by brightness. The image is displayed by the input/output module 505 or is converted to digital data and stored in the image storage module 504.

With regard to the detectors, the detector A 557 and the detector B 558 is disposed above the wafer and the detector C 559 and the detector D 560 are disposed at angles from the wafer. In the figure, the detector C 559 and the detector D 560 are in 180 degree symmetry relative to the wafer, but this angle does not need to be 180 degrees. The detector A 557 detects secondary electrons generated by the wafer 551 due to the illumination of the electron beam 555 on the wafer 551. The secondary electrons radiating in the Z direction in the figure are deflected in the direction of the detector A 557 due to the operation of the magnetic field and the electric field of an ExB deflector (not shown in the figure) disposed above the deflector 556. The image captured by the detector A will be referred to below as the “secondary electron image”.

Also, an energy filter 561 having a voltage difference Vf is disposed between the detector A 557 and the detector B 558. As a result, the secondary electrons discharged from the wafer with energy less than Vf do not pass through the filter and are detected by the detector A 557. The secondary electrons with energy greater than Vf pass through the filter and are detected by the detector B 558.

The image obtained from the signals detected by the detector B 558 will be referred to as the “energy filter image”. This energy filter image allows defects to be detected through voltage contrast differences occurring on the wafer surface.

FIG. 7 illustrates voltage contrast defects. This figure shows a cross-section of a semiconductor product. An SiO2 film is formed on an Si substrate, and plugs are formed from W (tungsten). The figure shows examples of normal contact area between a plug and the Si substrate, no contact area (an open defect), and a large contact area formed by two plugs connected to each other (a short defect).

When these types of contact area differences are present, the voltage at the wafer surface varies due to differences in the current paths (the dotted lines in the figure) from the wafer surface to the bottom surface. These voltage differences affect the intensity of the secondary electrons, allowing the defective areas and normal areas in the captured image to be detected as contrast differences.

To emphasize the differences between the voltage contrast defect areas and the normal areas, the differences in energy distribution of the secondary electrons generated from different areas are used. In regions with relatively low energy, significant differences in secondary electron intensity are not seen, but in regions with relatively higher energy, differences are detected in secondary electron intensities between normal areas and defect areas (open and short defects). Thus, Vf is set to an energy value that allows the differences in secondary electron intensities to be prominent so that only secondary electrons having an energy greater than a certain value are detected by the detector B 558. As a result, voltage contrast defects can be detected.

The detector C 559 and the detector D 560 detect secondary electron images of the wafer surface from angles to the left and to the right. The images detected by the detector C 559 and the detector D 560 are referred to as the “left/right images” in this description. This is because the images obtained from the detector C 559 and the detector D 560 are taken from the left and from the right, as opposed to the detector A 557, which detects secondary electron images from above the wafer.

Each defect is imaged so that their positions within the different images captured by the detectors are identical. In other words, identical coordinates on the different images will correspond to a single position on the wafer. In this example, the images are captured at the same time, but this is not necessary. The images can be captured with timing offsets.

When an electron beam image is captured, the illuminating electrons generally generate a charge-up effect in which the wafer becomes charged. When the wafer is charged up, the intensity distribution of the secondary electrons and the like from the wafer can change and result in a captured image that is out of focus. In such cases, the wafer can be illuminated with an ultraviolet light (ultraviolet light illumination system not shown in the figures) to let the charged electrons escape.

Furthermore, when capturing wafer images with review SEM processing, it is possible for charge-up during defect inspections using electron-beam visual inspection devices and the like to affect imaging during the reviewing operation. In such cases, the wafer can be illuminated with an ultraviolet light (ultraviolet light illumination system not shown in the figures) to let the charged electrons escape.

After imaging the defect position using imaging means described above, the stage is moved to a chip adjacent to the chip containing the defect to a position where the pattern is identical to that of the defect position. An image is captured in the same manner as described above. This image is referred to as the reference image. Reference images are detected by the detectors A, B, C, D (557-560) and are stored in the image storage module 504 in the same manner as the defect image. Once the defect images and the reference images have been captured for one defect, imaging is performed for the next defect. This sequence is repeated until all the defects to be processed by ADR have been imaged.

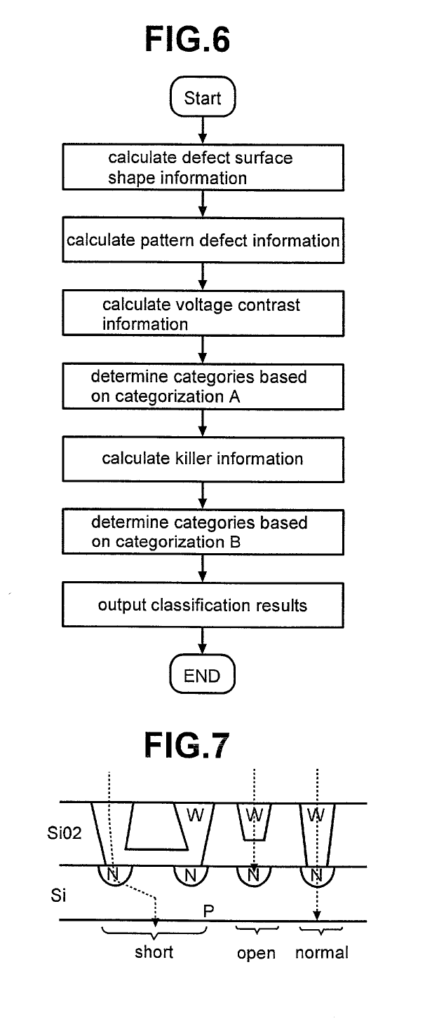

FIG. 6 shows a sequence of operations for an automatic defect classification operation (ADC processing) performed by the image classification module 503. This ADC processing can be performed synchronously or asynchronously with the imaging operation. In the ADC operation, automatic classification based on two different guidelines is performed and two category codes are output. In the following description, one will be referred to as categorization A and the other will be referred to as categorization B. Categorization A is a category classified using the visual appearance of a defect as the guideline. Categorization B is a category classified using the criticality of the defect as the guideline. First, the contents of categorization A will be described.

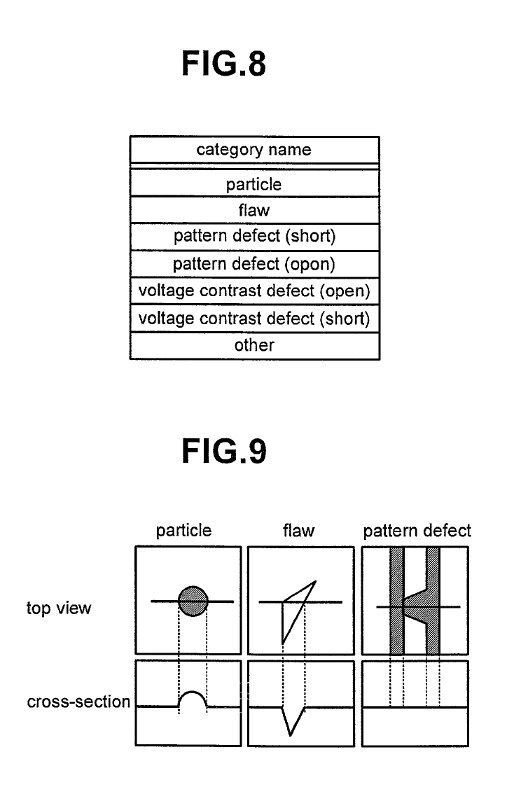

FIG. 8 shows an example of classification categories for categorization A. In categorization A, each defect is classified automatically as one of these categories. The “other” category is a category for defects that do not belong to any of the other categories. In categorization A, three types of defect information are calculated from the different captured images: (1) defect surface shape information; (2) pattern defect information; and (3) voltage contrast defect information. Then, the defect information is used to perform classification.

FIG. 9 shows differences in surface shapes for different defect variations. A particle adhesed to the surface results in a protrusion on the surface. A flaw defect results in an indentation that looks like a section has been dug out of the surface. Short patterns and open patterns (hereinafter referred to as pattern defects) do not show surface shape differences. This type of defect surface shape information, which indicates defect conditions, can be detected as quantitative data through the use of the left/right images.

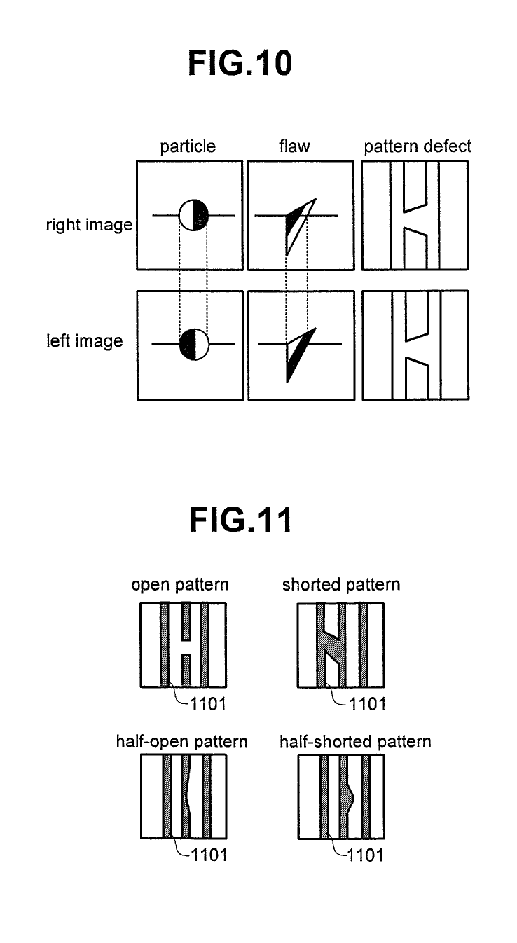

FIG. 10 shows schematic representations of left and right images of a particle, a flaw defect, and a pattern defect.

A protruding defect such as from a particle and an indented defect such as from a flaw will show opposite types of shadows in the left and right images. Defects where the surface is flat will not show shadows. This is due to the fact that when illumination is applied from one direction, shadows will be formed from the opposite direction. As a result, the direction in which shadows are formed and the defect position information obtained from the differential image resulting from the defect image and the reference image can be used to determine if a defect is protruding, indented, or neither. This provides the defect surface shape information.

Next, pattern defect information will be described. FIG. 11 shows schematic examples of pattern defects. Pattern defects include open defects, where a circuit pattern 1101 is broken, and short defects, where a circuit pattern is expanded and comes into contact with an adjacent pattern. Additionally, there are half-open defects, where the pattern is narrowed but not broken, and half-short defects, where the pattern is expanded but not in contact with an adjacent pattern. These defects can be detected using the method described below.

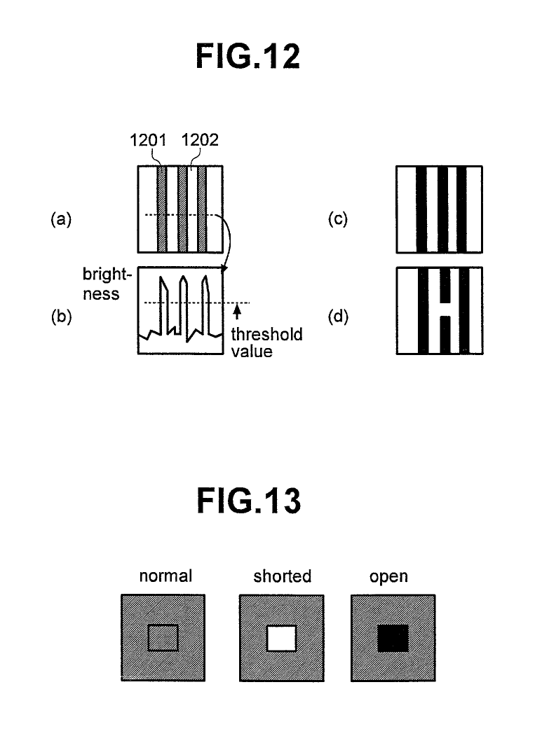

First, a circuit pattern area is recognized from a secondary electron reference image. FIG. 12 shows an example of a method for recognizing circuit patterns. FIG. 12(a) shows an image of circuit pattern areas 1201 and background areas 1202. FIG. 12(b) represents a cross-section of the signal intensity of the image, where the vertical axis represents image intensity, i.e., brightness. FIG. 12(b) shows that the circuit pattern areas are brighter than the background areas. Thus, by setting up a threshold value as shown in FIG. 12(b) and converting the image to a bi-level image, the circuit pattern areas can be emphasized as shown in FIG. 12(c), where the background areas are white and the circuit pattern areas are black. FIG. 12(d) shows the same operation performed on a defect image.

Circuit pattern defect information can be obtained by comparing the circuit pattern images of a defect image and a reference image, i.e., by comparing FIG. 12(c) and FIG. 12(d). For example, by studying the connections in the patterns (the black regions in the figure) around the defect position, an evaluation can be made of whether a circuit pattern is open or if there is contact (a short) with another circuit pattern. Also, a defect can be evaluated as open or short by calculating the differential image of these two circuit pattern images and determining if the region extracted from the difference is a circuit pattern area or a background area. The information obtained through these operations (circuit pattern open, circuit pattern half-open, circuit pattern short, circuit pattern half-short) is the circuit pattern defect information.

Next, voltage contrast information will be described. As mentioned in the discussion of imaging principles, an energy filter image can be used to detect voltage contrast defects. Voltage contrast defects refer to short or open patterns in vertical patterns on the wafer (e.g., a hole pattern connecting an upper-layer circuit pattern and a lower-layer circuit pattern). As shown in the schematic drawings in FIG. 13, short defects are brighter than normal areas in energy filter images, while open defects are darker than normal areas. Thus, by comparing the gradation values of defect areas with those of normal areas, a defect can be determined to be short or open. This provides the voltage contrast defect information.

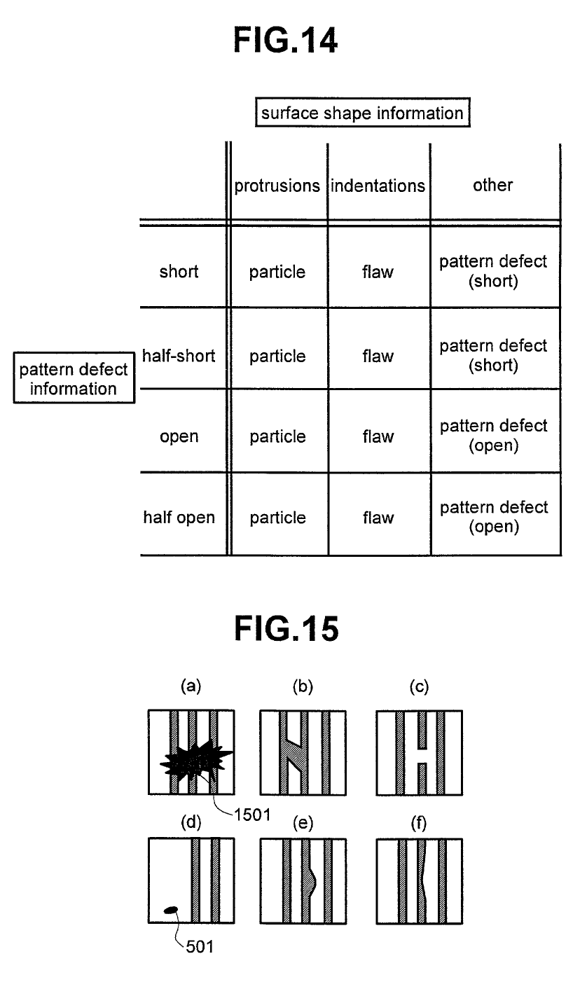

Once the three types of defect information described above have been calculated for a defect, this information is used to determine a category. FIG. 14 shows a table illustrating an example of category evaluation. To make the table easy to read, a categorization table based on surface shape information and circuit pattern defect information is shown. The table shows the relation between defect attributes obtained from surface shape information (protrusion, indentation, other) and attributes obtained from circuit pattern defect information (short, half-short, open, half-open).

The names shown in the fields of the table are the category names. These category names are selected from the categories shown in FIG. 8. With this table, if the surface shape information for a defect is “protrusion” the defect will be evaluated as a particle no matter what the circuit pattern defect information is. The voltage contrast information can be handled in the same manner.

By using this type of table, final categories can be determined from combinations of defect information obtained using different types of captured images. The values in this table can be modified as appropriate according to the particular semiconductor production line in which this automatic classification device is used. To do this, the operator uses the input/output module 505 to change the contents of the table according to the defects generated in the production line and the production processes involved. This concludes the discussion of categorization A.

Next, categorization B will be described. In categorization B, the degree of criticality that a defect has on the product is evaluated. The evaluation categories in categorization B are “killer defect” and “non-killer defect”.

In semiconductor products, LSI testers and memory testers are used to inspect electronic characteristics before shipment. One method for product inspection involves providing an input signal to a terminal on the semiconductor chip and comparing the signal output from another terminal with an expected value. This is used to determine if the product is good or bad. Faults occur because the electronic characteristics are different from those of good products. The majority of faults are due to defects generated in the production stage, especially contact between a circuit pattern and another circuit pattern, contact between a pattern and a particle, and the like.

FIG. 15(a), FIG. 15(b), and FIG. 15(c) are schematic diagrams showing examples of killer defects. FIG. 15(a) shows a particle 1501 bridging multiple circuit lines. In this case, the particle 1501 can cause the multiple circuit lines to be continuous. Thus, this type of particle defect will often be a killer defect in relation to electronic characteristics. FIG. 15(b) shows a circuit line shorting another circuit line. This can lead to a killer defect in relation to electronic characteristics. The same can be said for the open circuit pattern defect shown in FIG. 15(c) FIG. 15(d), FIG. 15(e), and FIG. 15(f) are schematic diagrams showing examples of non-killer defects. When the particle 1501 is adhesed as shown in FIG. 15(d), its position is away from patterned areas so it is not critical in relation to electronic characteristics. With the pattern defect (half-short) shown in FIG. 15(e) and the pattern defect (half-open) shown in FIG. 15(f), the defects will not be killer-defects in relation to electronic characteristics if the narrowed or expanded regions are small.

Taking these issues into consideration, the classification operation for categorization B will be described. First, a method using the classification results from categorization A will be described. In this method, all defects belonging to categories evaluated in categorization A are determined to be in the same categories in categorization B. For example, short defects and open defects can be classified as “killer defects” and halfshort defects and half-open defects can be classified as “non-killer defects”. In this case, an attribute of either “killer defect” or “non-killer defect” is applied to each of the categories from categorization A. When performing categorization B, this attribute can be looked up to allow automatic classification. These attributes can be set up flexibly by having the operator use the input/output module 505 to set up attributes.

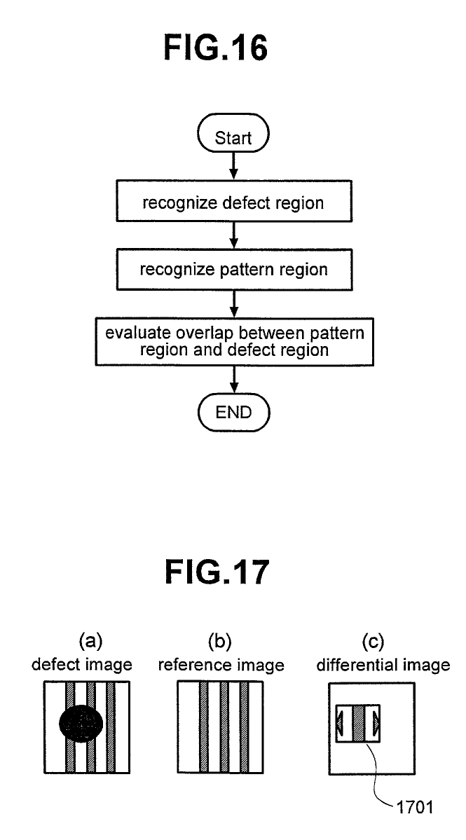

Next, an example will be described with particle defects where defects belonging to the same category in categorization A are classified in different categories by categorization B. FIG. 16 shows a sequence of operations performed to evaluate criticality in particle defects.

First, a defect area is determined with a differential image based on the defect and reference secondary electron images. In FIG. 17, FIG. 17(a) shows a defect image, FIG. 17(b) shows a reference image, and FIG. 17(c) shows a differential image. As shown in FIG. 17(c), the differences between the images may be dispersed, so parameters indicating a defect area can be stored as a rectangular area 1701, which is the maximum rectangular area that contains all the dispersed sections.

Next, a circuit pattern region is recognized from the secondary electron reference image. This circuit pattern recognition can be performed in the same manner that the circuit defect information is obtained in categorization A shown in FIG. 12. Evaluation of killer/non-killer defects is performed by examining the overlap between the recognized circuit patter areas and the defect area.

In the examples shown in FIG. 15(a) and FIG. 15(d), a defect is a “non-killer defect” if the particle area and the circuit pattern are close but not touching. However, it is also possible to use the image to calculate the distance between the circuit pattern area and the particle area and to change the categorization to “killer defect” if the distance is smaller than a certain value, i.e., if the distance between the circuit pattern area and the particle area is smaller than a certain distance. The same criticality evaluation can be performed for flaw defects in addition to particle defects. This is the automatic classification operation performed in categorization B.

In the description above, categorization B classified defects into “killer defects” and “non-killer defects”. However, more detailed classifications can be made. Also, the degree of “killer” or “non-killer”, i.e., a criticality rate (the probability that a defect will be critical), can be defined and used in classification.

As described above, the categorization A and the categorization B in the ADC sequence of operations results in automatic classification where two different categories are applied to each defect. This sequence of operations is repeated until all the defects to be processed by ADC have been processed.

Automatic classification can be performed for both categorization A and categorization B without the need for training data. In other words, this eliminates the work involved in creating training data, which includes definition of categories, collecting samples for each category, and registering training data.

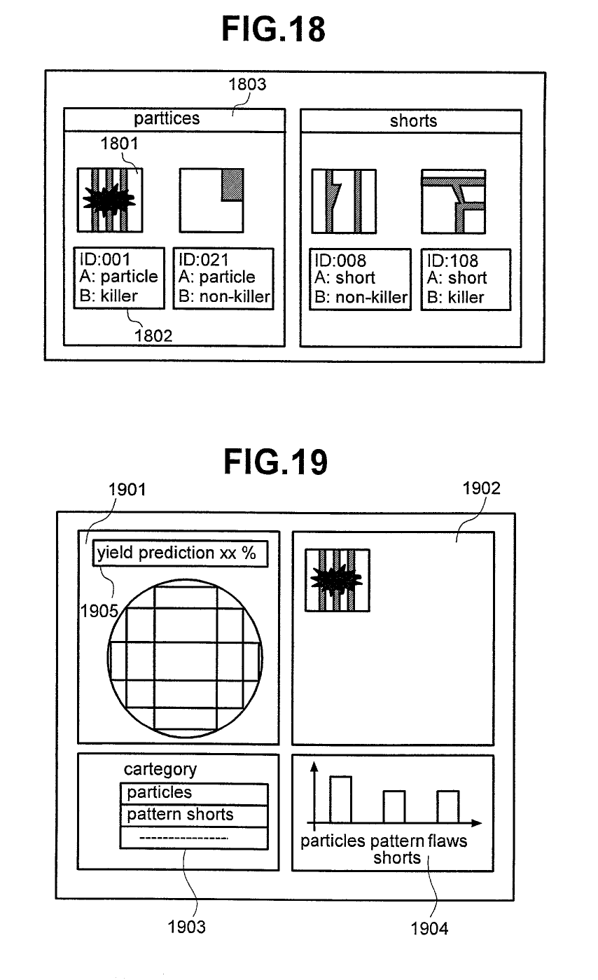

Next, a sample display of classification results will be shown. FIG. 18 shows an example of a display of categorized defects. In this figure, icons 1801 represent images in which defect images have been shrunk down. For each icon, a category display area 1802 displays a defect ID assigned by the inspection device and the categories from categorization A and categorization B. These icons are arranged in windows 1803. Defects placed in the same window belong to the same category. In FIG. 18, the windows represent categories from categorization A. The windows can be based on categorization B as well. Allowing the two display methods to be switched back and forth will make it easy for the operator to view the information.

In the example shown in FIG. 18, the category from categorization A is shown in both the top of the window 1803 and the category display area 1802, but it would also be possible to have it displayed in just one or the other.

FIG. 19 shows another example of a classification results display. A wafer map 1901 displays a map of defect positions on the wafer. An image display area 1902 displays a defect image selected from the map by the operator. It would also be possible to have multiple images (secondary electron image, left/right images, and the like) displayed in a row.

If the operator selects a category from a category display area 1903, defects corresponding to the selected category are highlighted on the map. This allows defect distributions to be observed by category. A graph area 1904 displays a graph of defect counts by category. The graph area 1904 can be used to display defect counts for each of the categories from categorization A and categorization B as well as defect counts for combinations thereof (e.g., defects that are both “particle” and “killer-defect”).

A yield display area 1905 displays a predicted yield. A predicted yield is a value indicating the number of chips estimated to be good relative to the total number of chips on the wafer. This is calculated based on the automatic classification results from categorization B. Each chip is examined for the presence of killer defects, and chips containing killer defects are considered faulty chips while chips not containing killer defects are considered good chips. This allows the predicted yield for the wafer to be calculated.

If it is known beforehand that there is a correlation between defect categories and processes in which the defects are generated, this screen can also be used to display estimates of processes in which defects are generated (not shown in the figure).

For example, if it is known beforehand for circuit pattern short defects that there is a problem in the preceding etching process, the user can use a pointing device such as a mouse to select a category from the category display area 1903. Then the estimated defect generation process based on the category name can be displayed on the screen. If defects belonging to a category selected by the user is displayed in a manner different from the other defects, the user can see both the process in which the defects were generated and the positions of the defects.

FIG. 19 shows the wafer map 1901, the image display area 1902, the category display area 1903, the graph area 1904, and the yield display area 1905 displayed on the screen at the same time. However, the present invention is not restricted to this. It would also be possible to have any number of items out of the five items above displayed in a combined manner, or the items can be individually, or the items can be combined with other display items.

For example, the wafer map 1901 and the yield display area 1905 can form one display screen. Alternatively, the wafer map 1901, the category display area 1903, and the yield display area 1905 can form one display screen. Alternatively, the wafer map 1901, the image display area 1902, and the yield display area 1905 can form one display screen.

Also, the image display area 1902 can display images and display categories (from categorization A and/or categorization B), as shown in FIG. 18.

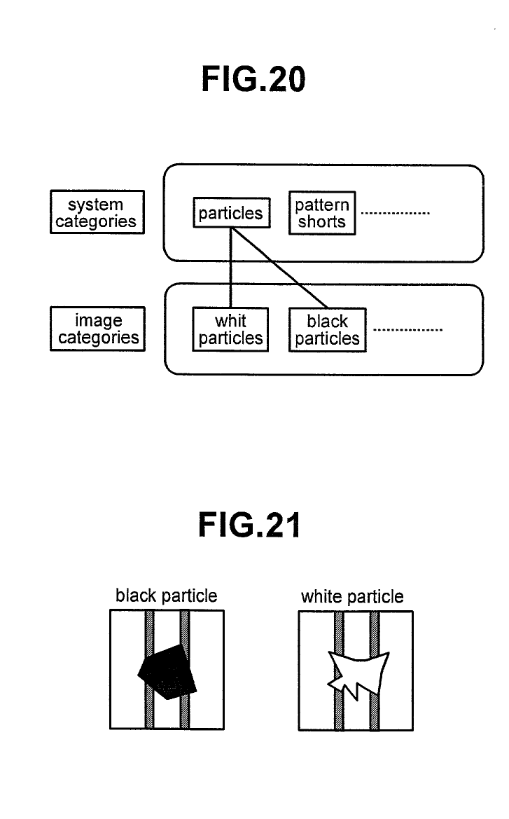

Next, another embodiment of the present invention will be described. FIG. 20 shows a category structure used in an automatic image classification device according to the present embodiment. The system categories referred to here are categories from categorization A of the embodiment described above. The image categories are categories created by the operator. The lines between the system categories and the image categories indicate links between categories, and each image category is included in the system category that it is linked to. A single system category can be linked to multiple image categories. These links allow a single system category to be linked to multiple image subcategories.

An example of image categories for the system category of “particles” will be described.

Some types of particles can be generated by different causes in a semiconductor production process. Since different measures are required to prevent these particles, they must be classified. Classifying these particle types is not possible with categorization A from the embodiment described above. Image categories are categories used to provide this type of detailed classification and are defined by the operator. Examples of image categories is shown in FIG. 21, which shows a block particle and a white particle. In this example, the use of image categories is illustrated when there are two types of particles with different colors.

First, training data is created to classify these two types of particle defects. This involves collecting multiple images such as those shown in FIG. 21 to be used as “black particle” and “white particle” image samples. Then, classification features are calculated and stored for each category. This results in the creation of image category training data. These features are quantifications of particle appearances such as image brightness and defect area. If, during categorization A of the automatic classification operation, one of the categories is linked to image categories, the training data is referenced to determine which linked category the entry should belong to. This allows categorization A to be performed with higher precision, i.e., the classification for use in setting up measures to prevent defects can be performed with higher precision.

Also, these image categories can be used to increase the precision of the classification performed in categorization B. In the embodiment described previously, particles that bridge circuit patterns can lead to continuity between circuit lines and are there evaluated as “killer defects”. However, if the particle is not conductive, it should be evaluated as a “non-killer defect” even if it bridges multiple circuit line patterns. In the previous example, there may be some data, e.g., molecular analysis results, to indicate that “black particles” are not conductive. In this case, these particles should be evaluated as “non-killer defects” regardless of their position.

To implement this, killer/non-killer flags can be set up for image categories in which it is known beforehand when defining training categories that all defects belonging to the category are “killer defects” or “non-killer defects”. When performing automatic classification, this information is referenced to perform categorization B.

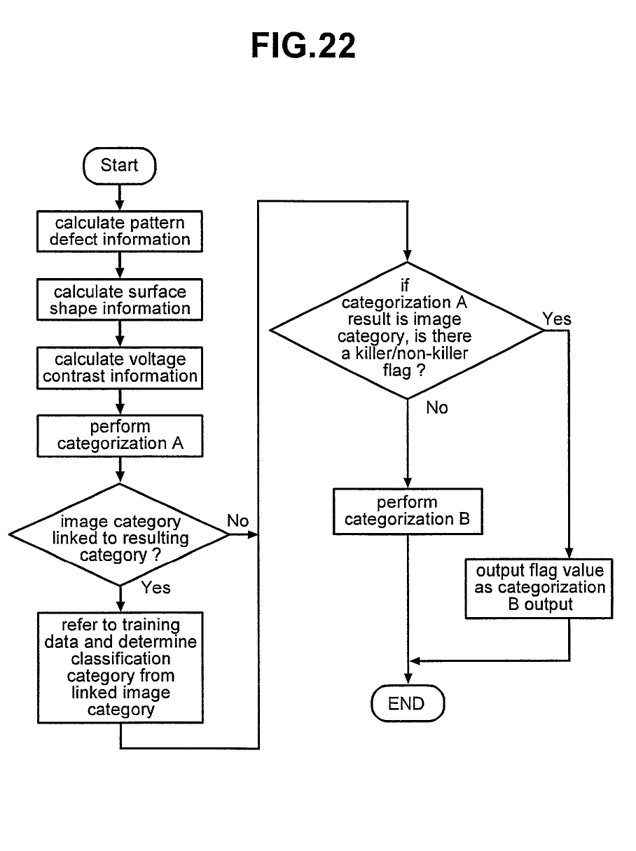

FIG. 22 illustrates the sequence of operations performed for automatic classification using category structures including image categories.

First, categorization A is performed. Specifically, (1) pattern defect information, (2) surface shape information, and (3) voltage contrast information is calculated from the captured images and a system category for categorization A are determined. Then, the determined system category is checked to see if it has links to image categories. If there are image categories, the image category most applicable is selected and this serves as the category determined by categorization A.

Next, categorization B is performed. If a defect is classified in an image category by categorization A, the image category is checked to see if a killer/non-killer defect flag is set up for it. If so, the flag is used as the classification result for categorization B. If not, or if the automatic classification result from categorization A is a system category, categorization B is performed in the same manner as the embodiment described above.

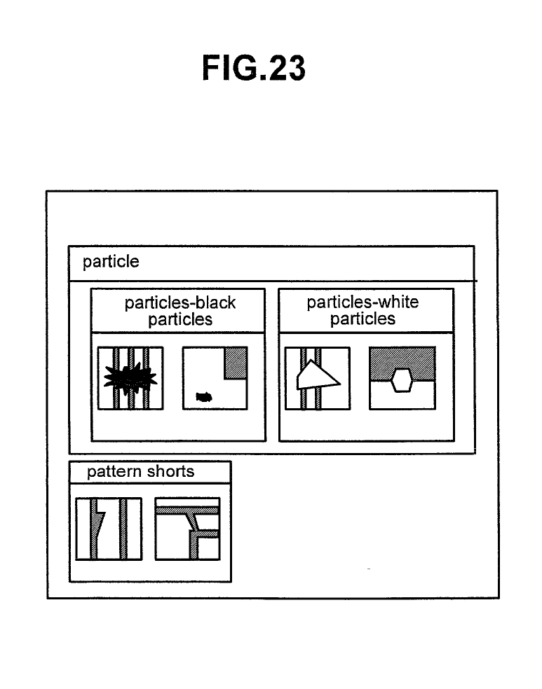

FIG. 23 shows a sample display of automatic classification results when image category training is performed. As in FIG. 18, each window shows a single category. In this figure, the windows display categories from categorization A. For categories (“particles”) with links to image categories, the category name and the image category name are displayed to distinguish these from system categories (e.g., “pattern shorts” in the figure) that do not have links to image categories.

If a system category has links to multiple image categories, as in the “particles” category shown in the figure, the results belonging to this category are displayed in a row to allow easy visual recognition that these belong to the same system category. As with FIG. 18, the screen FIG. 22 can be switched to windows based on categories from categorization B.

The above description presented the flow of operations for representative device architectures and automatic classification operations according to an embodiment of the present invention. In the examples presented in this description, four imaging detection systems capture images of defect areas using different features (discharged secondary electrons, reflected electrons, energy of absorbed electrons, and discharge directions thereof). These images are used to perform two classifications, categorization A and categorization B, using two different guidelines. However, the present invention is not restricted to this.

For example, three different classifications can be implemented by introducing classification based on a new categorizing guideline C. An example of categorization C is classification based on defect size. In this case, the distribution of killer/non-killer defects (the classification from categorization B) can be seen in terms of different defect sizes, and correlation with defect appearances (the classification from categorization A) can be seen. Classification based on defect size refers to, for example, using the longest defect diameter and dividing defects into groups such as S (0.5 microns or less), M (0.5.−1 micron), and L (1 micron or greater). Thus, as many categorization types based on different guidelines can be defined as needed. This provides more useful data to set up defect prevention measures and the like.

Also, in addition to semiconductor products, the ideas behind the present invention can be implemented for defect inspections and defect classifications in the production of various types of industrial products.

With the embodiments of the present invention, defects generated in a semiconductor wafer production process are classified automatically based on defect appearances so that information useful for determining the cause of defects can be provided. Furthermore, defect classification is performed using the criticality of defects to the product as a guideline, which is a guideline that is distinct from the causes of defects. This provides product yield prediction information, which is needed for setting production planning and the like. Also, the work needed to set up a defect database for classification is reduced.

The invention may be embodied in other specific forms without departing from the spirit or essential characteristics thereof. The embodiments described above are therefor to be considered in all respects as illustrative and not restrictive. Therefore, the scope of the invention should be based on the appended claims rather than on the foregoing description, and all changes which come within the meaning and range of equivalency of the claims are therefore intended to be embraced therein.

What is claimed is:

1. A method for classifying defects comprising:
imaging an inspected object;
extracting an image of a defect candidate from an image obtained by said imaging step;
classifying said extracted defect candidate image into a first category;
classifying said extracted defect candidate image into a second category; and
displaying on a screen said extracted defect candidate image and information relating to said classification into said first category and information relating to said classification into said second category.

2. The method for classifying defects as described in claim 1 wherein said imaging of said inspected object is performed by illuminating and scanning an electron beam focused on said inspected object and detecting, in synchronization with said scanning, secondary electrons generated from said inspected object by said illumination.

3. The method for classifying defects as described in claim 1 wherein said first category relates to defect criticality.

4. The method for classifying defects as described in claim 3 wherein said second category relates to defect type.

5. The method for classifying defects as described in claim 4 wherein said defect type includes one or more of the following: particle defects, flaw defects, circuit pattern short defects, and circuit pattern open defects.

6. A method for classifying defects comprising:
imaging an inspected object to obtain an image;
extracting an image of a defect candidate from said image obtained by said imaging step;
classifying said extracted defect candidate image into at least one defect type;
evaluating criticality of defect of said defect candidate image classified into said at least one defect type; and
displaying on a screen said defect candidate image along with information relating to the type of said at least defect type and said criticality of defect.

7. The method for classifying defects as described in claim 6 wherein said imaging of said inspected object is performed by illuminating and scanning an electron beam focused on said inspected object and detecting, in synchronization with said scanning, secondary electrons generated from said inspected object by said illumination.

8. The method for classifying defects as described in claim 6 wherein said defect types for classification include one or more of the following: particle defects, flaw defects, circuit pattern short defects, and circuit pattern open defects.

9. A method for classifying defects comprising:
imaging an inspected object;
extracting images of defect candidates from said inspected object;
classifying said extracted defect candidate images into a first category;
classifying said extracted defect candidate images into a second category, said second category relating to predicted yield from said inspected object; and
displaying on a single screen a distribution on said inspected object of said defect candidates classified in said first category and information relating to said first category classification and information relating to results of said second category classification.

10. The method for classifying defects as described in claim 9 wherein said imaging of said inspected object is performed by illuminating and scanning an electron beam focused on said inspected object and detecting, in synchronization with said scanning, secondary electrons generated from said inspected object by said illumination.

11. The method for classifying defects as described in claim 9 wherein an image of said defect candidate is also displayed on said screen.

12. A device for classifying defects comprising:
an imaging component to obtain an image of an inspected object, having a defect candidate;
an extracting component, coupled to said imaging component, to extract an image of said defect candidate;
a first classifying component, coupled to said extracting component, to classify said image of said defect candidate into a first category;
a second classifying component, coupled to said extracting component, to classify said image of said defect candidate into a second category; and
an outputting component, coupled to said first and second classifying components, to output said image of said defect candidate and first category information of said defect candidate and second category information of said defect candidate.

13. The device for classifying defects as described in claim 12 wherein said imaging component includes:
an electron beam optical system to illuminate and scan an electron beam focused on said inspected object;
a detecting component to detect, in synchronization with said scanning, secondary electrons generated from said inspected object by said illumination of said electron beam focused on said inspected object by said electron beam optical system; and
an imaging forming component to form an image based on said secondary electrons detected by said detecting component.

14. The device for classifying defects as described in claim 12 wherein either said first classifying component or said second classifying component classifies said defect candidate in a category relating to defect criticality.

15. The device for classifying defects as described in claim 12 wherein either said first classifying component or said second classifying component classifies said defect candidate in a category relating to defect type.

16. The device for classifying defects as described in claim 15 wherein said defect type includes one or more of the following: particle defects, flaw defects, circuit pattern short defects, and circuit pattern open defects.

17. A device for classifying defects comprising:
means for imaging imaging an inspected object;
means for extracting defect candidates extracting an image of a defect candidate from an image obtained from said imaging means;
means for classifying first categories classifying said image of said defect candidate extracted by said defect candidate extracting means into a first category;
means for classifying second categories classifying said image of said defect candidate extracted by said defect candidate extracting means into a second category; and
means for outputting displaying on a single screen a distribution on said inspected object of said defect candidates classified in said first category and information relating to said first category classification and information relating to results of said second category classification.

18. A device for classifying defects as described in claim 17 wherein said imaging means includes:
an electron beam optical system means illuminating and scanning an electron beam focused on said inspected object;
means for detecting detecting, in synchronization with said scanning, secondary electrons generated from said inspected object by said illumination of said electron beam focused on said inspected object by said electron beam optical system means; and
means for forming images forming a secondary electron image of said inspected object based on a secondary electron signal detected by said detecting means.

19. A device for classifying defects as described in claim 17 wherein said first category classifying means classifies said defect candidates by defect type.

20. A device for classifying defects as described in claim 17 wherein said defect type includes particle defects, flaw defects, circuit pattern defects, and voltage contrast defects.

21. A device for classifying defects as described in claim 17 wherein said second category classifying means classifies said defect candidates by defect criticality.

22. A device for classifying defects as described in claim 17 wherein said outputting means outputs on said screen information relating to predicted yield from said inspected object as said information relating to results of said second category classification.
